(19) United States
(12) Patent Application Publication
(10) Pub. No.: US 2003/0205317 A1
(43) Pub. Date: Nov. 6, 2003

(54) Method for sealing flat panel displays and bonding optical component parts

(76) Inventor: Chau Thi Minh Ha, Chicago, IL (US)

Correspondence Address: Michael R. Hull, MARSHALL, GERSTEIN & BORUN, Sears Tower, Suite 6300, 233 S. Wacker Drive, Chicago, IL, 60606-6357, US

(21) Appl. No.: 10/136,704

(22) Filed: May 1, 2002

(51) Int. Cl. B32B 31/00

(52) U.S. Cl. 156/275.7; 428/615

(57) ABSTRACT

A method for assembling a flat panel display is disclosed whereby the conductive layers disposed on the inside surfaces of the two panels to be laminated are connected or laminated together with a pressure-sensitive adhesive or a latent-cure adhesive. Protective insulating layers on the conductive layers disposed on the inside surfaces of the panels have been eliminated. The adhesive connecting the opposing conductive layers serves as a suitable insulating layer. An improved flat panel display whereby the conductive layers on opposing panels is connected with either a latent-cure adhesive or a pressure-sensitive adhesive is also disclosed. Methods of laminating panels of EL displays and methods of laminating substrates of optoelectronic devices are also disclosed.

### TECHNICAL FIELD

A novel method for assembling, sealing or laminating flat panel display units and opaque optical components parts is disclosed. More specifically, a method for laminating flat panel display units is disclosed which involves the use of an insulating adhesive to connect the conductive layers disposed on the inside surfaces of two opposing spaced-apart panels. The disclosed method eliminates the need for additional insulating layers disposed on the conductive layers. The disclosed method is applicable to both rigid and flexible panels such as glass or plastic panels. The disclosed method is also used for laminating transparent, semi-transparent or opaque substimates used in flat panel displays and in optoelectronics.

### BACKGROUND

Until recently, the cathode ray tubes (CRTs) has been the principal electronic device for displaying visual information. The widespread usage of the CRT may be ascribed to the remarkable quality of the display characteristics in the realms of color, brightness, contrast and resolution. One major feature of the CRT permitting these qualities to be realized is the use of a luminescent phosphor coating on a transparent faceplate.

Conventional CRT's however, have the disadvantage that they require significant physical depth, i.e., space behind the actual display surface, making them bulky and cumbersome. Furthermore, these devices consume significant amounts of power.

Recently, flat panel displays (FPDs) have become more popular in today's society. These displays are being used more frequently, particularly to display the information of computer systems and other devices. Typically, flat panel displays are lighter and utilize less power than conventional CRT display devices.

There are different types of flat panel displays. One type of flat panel display is known as a cold cathode field emission display (FED). Cold cathode FED's are similar to CRT displays in that they use electrons to illuminate a cathodoluminescent screen. The electron gun is replaced with numerous emitter sites. When activated by a high voltage, the emitter sites release electrons which strike the display screen's phosphor coating. As in CRT displays, the phosphor releases photons which are transmitted through the display screen forming a visual image to a person looking at the screen.

In order to obtain proper operation of the flat panel display, it is extremely important for a FED of the cold cathode type to maintain an evacuated cavity between the emitter sites (acting as a cathode) and the display screen (acting as a corresponding anode). The typical cold cathode FED is evacuated to a pressure of 10⁻⁶ Torr or less. This reduced atmospheric pressure is required to allow electron emission. In addition, since there is a high voltage differential between the screen and the emitter sites, the reduced pressure is also required to prevent an electrical breakdown. In order to maintain the low pressure in the cavity, the outer panels of the display must be sealed together with a suitable sealing adhesive.

Another popular flat panel display is a plasma based or gas discharged display. Plasma based flat panel displays generally utilize an enclosed gas or gas mixture in a partially evacuated cavity. Crossed conductors (acting as opposed electrodes) are placed within the cavity to break down the gas into a plasma of electrons and ions causing a visible glow. In a monochrome monitor, a light emitting gas, such as neon, or light generating phosphors are used to generate visual images. Generally, each display pixel has at least one corresponding crossing point.

A colored plasma display utilizes an array of display pixels wherein each individual display pixel is comprised of a trio of color generating phosphors (that is, each pixel is split into three colored parts, which alone or in combination create colors when activated). Accordingly, the colored display pixel would have three crossing points corresponding to each color generating phosphor. Color images are created by exciting the appropriate color generating phosphors.

Other promising flat panel displays include electroluminescence (EL) displays, also known as organic electroluminescence (organic EL) displays, organic light emitting diode (OLED) displays and polymeric light emitting diode (PLED) displays, all of which are capable of color emissions, have very moderate power requirements, are light weight and are flexible.

In order to obtain proper operation of the gas discharged flat panel display, it is necessary that a partial vacuum be maintained within the cavity containing the crossed conductors and the gas. The partial vacuum is required to maintain the minimum firing voltage of the gas disposed within the cavity. Again, in order to maintain the low pressure inside the cavity, the outer panels must be sealed together with a suitable sealing adhesive.

A schematic illustration of a typical flat panel display 10 is illustrated in FIG. 1. The top panel 11 includes a film 12 such as polyester, PET, PS, PEN, PVC, etc., disposed between a hard coat layer 13 and a conductive film 14, which is typically indium-tin-oxide (ITO). A second or bottom panel 15 typically includes a glass or plastic panel 16 with an inner surface coated with an ITO conductive layer 17 or cathode layer such as Ca, Mg, etc. The conductive layers 14 and 17 each include an inner surface 18, 19, respectively, that are partially coated with conductive layers shown at 21, 22. The conductive layers 21 that are associated with the first panel 11 are, in turn, coated with insulating layers 23 which prevent any short circuiting between adjacent conductive layers 21 or opposing conductive layers 21, 22. Similarly, the conductive layers 22 associated with the second panel 15 are also coated with insulating layers 24. Dot spacers mounted to the inner surface 19 of the conductive layer 17 of the second panel 15 are shown at 25. Adhesive material shown at 26 is used to connect the opposing panels 11, 15 together. Typically, the adhesive material 26 is a thermally cured adhesive or a photo-curable adhesive that will set-up rapidly. Accordingly, after the adhesive 26 is applied to either or both of the conductive layers 23, 24, the panels 11, 15 must be assembled quickly so that the adhesive material 26 can be cured to provide a suitable structural connection between the panels 11, 15 and seal the chamber 27.

One disadvantage of the assembly process described above involves the use of the thermally curable or photo-curable adhesive 26. These adhesives dry or set-up quickly and therefore there can be no delay in assembling the panels 11, 15 once the adhesive material 26 is applied. Further, currently used adhesive material 26 does not serve as an adequate insulator and, hence, the additional insulating coatings 23, 24 are required to prevent short circuiting.

Thus, there is a need for an improved assembly process for flat panel displays which can eliminate the number of layers required and which can utilize an adhesive application and curing process that is easier to employ and less susceptible to defects caused by premature setting of the adhesive material 26.

Further, for EL displays, multiple layers of flexible plastic panels are required to provide adequate protection of the diode material from moisture or air. In order to meet the durability requirements for television and TVA monitors, a laminating adhesive is required that hard bonds to surfaces such as plastic materials (PET, PES, PNB, etc.) and which also provide optically transparent films. Currently available adhesives are unable to provide adequate bonding to plastic materials in combination with the requisite transparency. As a result, transparent adhesives are used which do not normally have good adhesion to plastic substrates, so manufacturers are required to pre-treat the substrates by corona etching, ozone, flame or other treatment methods prior to application of the adhesive to the substrate. While a few adhesives do provide the proper adhesion to plastic substrates, they are not completely transparent or have a yellow tint in color and therefore do not provide adequate transparency.

Thus, there is also a need for an improved adhesive for use in fabricating EL displays which can bond to plastic substrates without pre-treating the substrates and which also are transparent.

In the case of optoelectronics, the substrates of many devices are opaque. The conventional way to bond opaque substrates is laser welding, which is costly and which introduces substantial amounts of heat into the system.

Thus, there is also a need for improved adhesives which can bond opaque substrates without resorting to laser welding.

### SUMMARY OF THE DISCLOSURE

In satisfaction of the aforenoted needs, methods of laminating two panels of a flat panel display are disclosed. One method comprise: providing a first panel with an inner surface partially coated with a first conductive layer; providing a second panel with an inner surface partially coated with second conductive layer; applying adhesive directly to at least one of the first and second conductive layers; and laminating the first panel to the second panel by aligning the first and second conductive layers with the adhesive sandwiched therebetween to adhere the first conductive layer to the second conductive layer with the adhesive.

In a refinement, methods of laminating substrates together for use in EL displays are also disclosed. One method comprises: providing a first substrate; coating the first substrate with adhesive; stacking a second substrate on the adhesive; curing the adhesive by exposing the two substrates and adhesive to UV light; and, optionally, laminating the two adhesives together. The lamination step would be applicable to processes where a pressure sensitive adhesive is used. Laminating would not be required if a latent-cure adhesive is used.

Another lamination method comprises: coating a first substrate with adhesive; curing the adhesive under UV light to provide a high tack adhesive coating on the first substrate; stacking or applying a second substrate on the high tack adhesive; and laminating under pressure ranging from about 20 to about 50 psi. Heat lamination could also be utilized. In a related method, instead of stacking or applying a second substrate on the high tack adhesive, release paper could be applied to the high tack adhesive and the first substrate, high tack adhesive and release paper could be stored while preparation of the second substrate or other processes are completed. The related process would include removal of the release paper, stacking or applying the second substrate on the high tack adhesive and laminating the first and second substrates together under pressure or using a heat lamination as described above.

The substrates or flexible films that are laminated in the above methods may also be coated with inorganic materials such as SiN, SiO, etc.

The adhesive employed provides a satisfactory insulation barrier between the conductive layers of the first and second panels. Hence, an additional insulation layer disposed on the conductive layers is not necessary, thereby eliminating at least one manufacturing step.

Further, in a refinement, the adhesive is a pressure-sensitive adhesive (PSA) which enables the adhesive to be applied to one or both of the conductive layers and the panels assembled together. The pressure-sensitive adhesive will hold the panels in the correct position and provide the seal for the chamber disposed between the two panels while waiting for the adhesive to be cured. In a further refinement, the pressure-sensitive adhesive is curable with ultra-violet light. The laminating process may take place immediately or may be delayed for up to several hours as the pressure-sensitive adhesive will maintain the integrity of the assembled structure.

In a further refinement, the pressure-sensitive adhesive comprises: at least one oligomer having a glass transition temperature Tg of less than or about 25° C.; at least one monomer; at least one resin; at least one adhesion promoter; and at least one photo initiator.

In still a further refinement, the pressure-sensitive adhesive comprises:

from about 5 to about 80 wt % of at least one oligomer having a glass transition temperature Tg of less than or about 25° C.; from about 0 to about 70 wt % of at least one monomer; from about 5 to about 80 wt % of at least one resin; from about 0 to about 20 wt % of at least one adhesion promoter; and from about 0 to about 10 wt % of at least one photo initiator.

In yet another refinement, the pressure-sensitive adhesive comprises: from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof; from about 0 to about 70 wt % of at least one monomer selected from the group consisting of isobornyl acrylate, hexanediol diacrylate, phenoxyethyl acrylate and mixtures thereof; from about 5 to about 80 wt % of at least one resin selected from the group consisting of thermoplastic terpenes, thermoplastic polyterpenes, styrene butadiene, tall oil resin and mixtures thereof; from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof; from about 0 to about 10 wt % of at least one adhesion promoter selected from the group consisting of zirconium salt, titanium salt, and mixtures thereof; and from about 0 to about 10 wt % of at least one photo initiator selected from the group consisting of benzophenone, ethyl-4-(dimethylamino)benzoate, benzil dimethyl ketal and mixtures thereof.

In another refinement, the pressure-sensitive adhesive comprises: from about 40 to about 70 wt % of a urethane diacrylate oligomer; from about 5 to about 15 wt % of ethoxy ethyl acrylate monomer; from about 15 to about 35 wt % of a terpene resin; from about 1 to about 5 wt % of gamma-mercaptopropyltrimethoxysilane; and from about 5 to about 10 wt % benzil dimethyl ketal.

In another related refinement, instead of being a pressure-sensitive adhesive (PSA), the adhesive is a latent-cure adhesive. The latent-cure adhesive may comprise an epoxy based oligomer, a reactive diluent, an adhesion promoter and a photo initiator.

In a further refinement, the latent-cure adhesive comprises: from about 5 to about 95 wt % of at least one epoxy oligomer; from about 0 to about 70 wt % of at least one reactive diluent; from about 0.1 to about 10 wt % of at least one photo initiator; and from about 0 to about 10 wt % of at least one adhesion promoter.

The PSAs and latent-cure adhesives described above achieve at least 80% transmission in the 250-900 nm region.

The technique for applying the adhesive, either pressure-sensitive or latent-cure, may involve screen printing, offset printing, pattern printing, syringe dispensing or precision dispensing. Other application techniques of the adhesive material to the conductive layers will be known and apparent to those skilled in the art.

In a further refinement, the PSA or latent adhesive is applied to the optical components parts, then UV radiation is used to activate the adhesive, then two optical parts are joined together for final bonding.

An improved flat panel display is also disclosed which comprises: a first panel with an inner surface partially coated with a first conductive layer, a second panel with an inner surface partially coated with second conductive layer, and the first and second conductive layers being connected with an adhesive that is sandwiched therebetween and without the presence of any additional insulating material disposed between the first and second conducting layers other than the adhesive.

### BRIEF DESCRIPTION OF THE DRAWINGS

FIG. 1 is a schematic illustration of a flat panel display assembled in accordance with the prior art;

FIG. 2 is a schematic illustration of a flat panel display assembled in accordance with the disclosure;

FIG. 3 is a flow diagram illustrating a disclosed lamination method; and

FIG. 4 is another flow diagram illustrating another disclosed lamination method.

### DETAILED DESCRIPTION OF THE PRESENTLY PREFERRED EMBODIMENTS

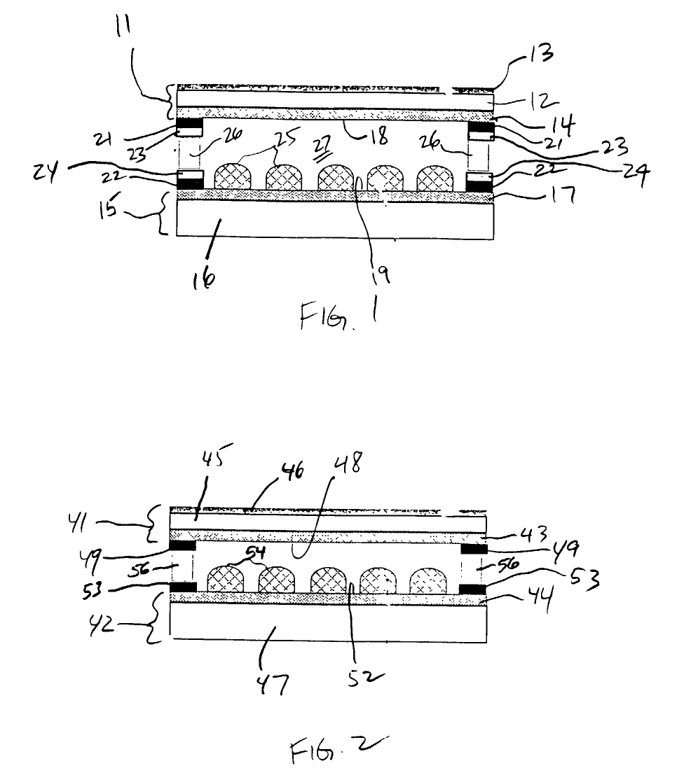

Similar to FIG. 1, the flat panel display 40 shown in FIG. 2 includes a first panel 41 connected to a second panel 42. The panels 41 and 42 each include conductive ITO layers 43, 44, respectively. The first panel 41 also includes a polyester film 45 sandwiched between the ITO layer 43 and a hard coat layer 46. The ITO layer 44 of the second panel 42 is coated onto a glass or substrate layer 47. The inner surface 48 of the first panel 41 is partially coated with one or more conductive layers shown at 49. Similarly, the inner surface 52 of the second panel 42 is also coated with one or more conductive layers shown at 53. The inner surface 52 of the second panel 42 is also coated with a plurality of dot spacers shown at 54.

The reader will note that the conductive layers 49 and 53 of the first panel 41 and second panel 42, respectively, are not coated with additional insulating layers such as that shown at 23, 24 in FIG. 1. Instead, adhesive material 56 connects opposing conductive layers 49, 53 together. The adhesive material 56 may be a pressure-sensitive adhesive or a latent-cure adhesive. The adhesive material 56 provides a satisfactory insulating barrier between the opposing conductive layers 49, 53. Thus, the manufacturing step of applying insulating layers 23, 24 to the conductive layers 21, 22 as shown in FIG. 1 has been eliminated.

Further, by using the pressure-sensitive of latent-cure adhesives of the present invention, the laminating process may be delayed a substantial period of time after application of the adhesive 56. By enabling the laminating process to be delayed, a roll to roll process can be utilized to provide low cost manufacturing and better inventory management.

In assembling the flat panel display 40 shown in FIG. 2, the panels 41 and 42 are provided already coated with their respective conductive layers 49, 53. Adhesive material 56 is applied to one or both of the conductive layers 53 and the panel assembled or laminated together as illustrated in FIG. 2.

A suitable pressure-sensitive adhesive includes one or more oligomers, one or more monomers, one or more resins, one or more adhesion promoters and one or more photo initiators. Preferably, the oligomers have a glass transition temperature T_{g} of less than or about 25° C.

Suitable oligomers include aliphatic urethanes, aromatic urethanes and mixtures thereof. The oligomers may be present in an amount ranging from about 5 wt. % to about 80 wt. %. Preferably, the oligomer content constitutes from about 40 wt. % to about 70 wt. % of the adhesive, more preferably about 55 wt. %. One suitable oligomer is sold under the trade symbol CN962 by Sartomer Corporation of Exton, Pennsylvania. Other suitable oligomers provided by this supplier include other aliphatic urethanes, other than CN962, such as CN953, CN964 and CN966. Still other suitable oligomers provided by this supplier include aromatic urethanes sold under the trade symbols CN971A80 and CN978. A suitable polyester acrylate that can be used as the oligomer is sold under the trade symbol CN130.

The monomer content can range from 0 to 70 wt. %, more preferably from about 5 to 15 wt. %, still more preferably, about 9 or 10 wt. %. Suitable monomers include isobornyl acrylate, hexanediol diacrylate, phenoxyethyl acrylate and mixtures thereof. Such monomers are readily available on a commercial basis.

The resin content can range from about 5 to about 80 wt. %, more preferably about 15 to about 35 wt. %, still more preferably about 25 or 26 wt. %. The resin is preferably a tackifier resin, such as a thermoplastic terpene or polyterpene. Other suitable tackifier resins include styrene butadiene and tall oil resins. Resins sold under the trademarks SYLVATAC RE 40, UNI-TAC 70, SYLVARES-ZT 115 LT can be purchased from Arizona Chemical Ltd. of Jacksonville, Fla.

The adhesion promoters may be present in an amount ranging from about 0 to about 20 wt. %, preferably about 0 to about 10 wt. % cross-linkable adhesion promoters and from about 0 to about 10% non-cross-linkable adhesion promoters. Still more preferably, a single cross-linkable adhesion promoter can be employed in an amount ranging from about 0 to 5%, preferably about 3 wt. %. Suitable adhesion promoters include polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl) tetrasulfane, zirconium salt and titanium salt. All of the above list adhesion promoters are available from Dow Chemical Co. of Midland, Mich., Witco Corporation, a division of Crompton Corporation, of Greenwich, Conn. and other suppliers.

The photo initiators should be present in amounts ranging from about 0 to about 10 wt. %, more preferably from about 5 to about 10 wt. %, still more preferably about 7 wt. %. Suitable photo initiators include benzophenone, ethyl-4-(dimethylamino)benzoate, benzil dimethyl ketal and mixtures thereof. Such photo initiators are available from Ciba-Geigy AG of Basel, Switzerland, Sartomer and other suppliers that will be known to those skilled in the art.

One preferred pressure-sensitive adhesive formulation is listed in Table I.

TABLE I

| Formulation: AP 1700 | Weight % |
|---|---|
| CN 982 (low Tg oligomer) | 55 |
| Ethoxy ethoxy ethyl acrylate (acrylate monomer) | 09 |
| Uni-tac 70 (tackifier resin) | 26 |
| gamma-mercaptopropyltrimethoxysilane (adhesion promoter) | 03 |
| Benzin dimethyl ketal (photo initiator) | 07 |

The pressure-sensitive adhesives described above may be printed using screen printing, offset printing, pattern printing, syringe dispensing and precision dispensing. Suitable screen-printing procedure involves the use of a standard polyester mesh screen 355-420 PW (English system) or 140-165 PW (metric system). An application pressure of 30 psi is recommended with a distance of 5.5 to 6.0 mm between the screen and the conductive layer surface 49, 53. Curing can be obtained with a WV (ultra violet) dose of 250 to 400 mJ/cm². A laminating pressure of 30 to 50 psi or 3-4 Kgf/cm². The pressure-sensitive adhesives described above need no refrigeration.

In addition to the pressure-sensitive adhesives described above, latent-cure adhesives can also be employed. Suitable latent-cure adhesives can comprise an epoxy oligomer, a reactive diluent, an adhesion promoter and a photo initiator.

The epoxy oligomer is preferably present in an amount ranging from about 5 to about 95 wt. %. Suitable epoxy oligomers include bisphenol-A or bisphenol-F epoxies. These oligomers are sold by Dow Chemical, Union Carbide of Danberry, Conn., Shell Company of Houston, Tex. and Ciba-Geigy.

Suitable reactive diluents include alcohols, polyols, polyether polyols and vinyl ethers. More specific examples include ethylene glycol, n-propyl alcohol, n-butyl alcohol, hexanediol and limonene dioxide. The reactive diluents should be present in an amount ranging from about 0 to about 70 wt. %. The reactive diluents listed above can be obtained from BASF of Germany and DuPont of Wilmington, Del.

The adhesion promoters should be present in an amount ranging from about 0 to about 10 wt. %. Suitable adhesion promoters include silane functional epoxies such as those sold under the trademarks A 187 and A 186 from Witco Corporation.

Suitable photo initiators include triarylsulfonium hexafluoroantimonate salts, triarylsulfonium hexafluorophosphate salts and mixtures thereof. Such photo initiators are sold under the trademarks UVI 6974, UVI 6990, CD 1010, CD 1011 and are available from Ciba-Geigy, Union Carbide, Sartomer and other suppliers.

The latent-cure adhesives can be applied using the screen printing technique discussed above or any suitable offset printing, pattern printing, syringe dispensing or precision dispensing techniques described above. The latent-cure adhesives may also be cured using the UV doses described above.

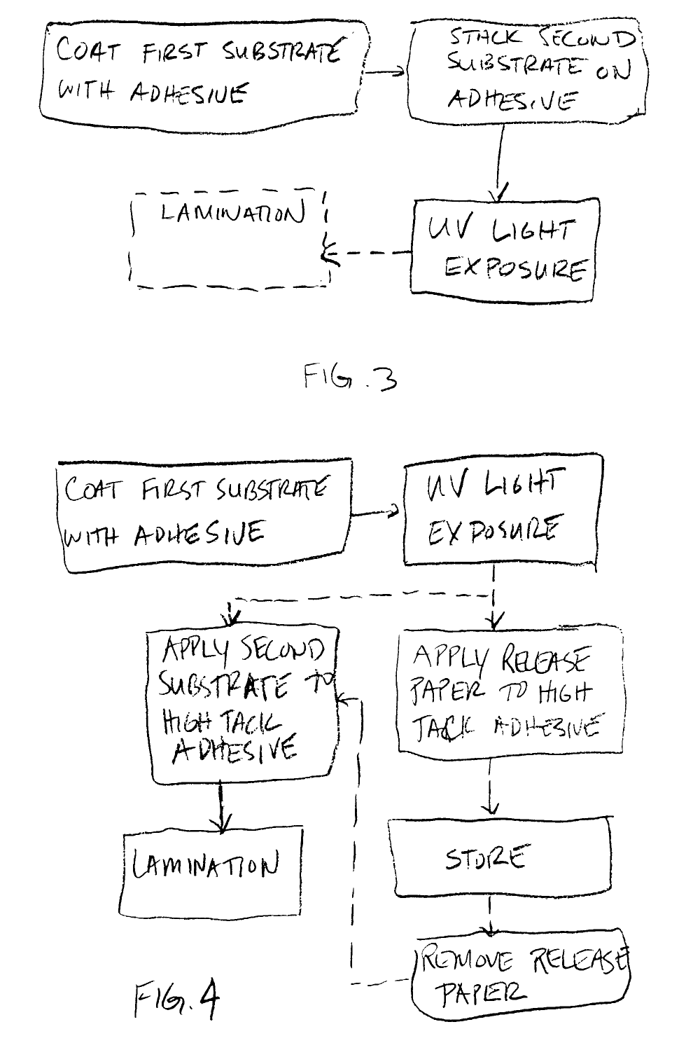

As described in FIGS. 3 and 4, the pressure sensitive adhesives and latent-cure adhesives may be utilized in laminating processes. In FIG. 3, one of the adhesives described above is coated on a first substrate and a second substrate is applied to or stacked onto the first substrate with the adhesive disposed therebetween. Then, the stacked structure is exposed to UV light to cure the adhesive. An additional lamination step may or may not be needed.

In FIG. 4, the first substrate or film is coated with an adhesive and then cured under UV light to provide a “high tack” adhesive. At this point, the substrate and high tack adhesive may be stored by applying a release paper to the high tack adhesive. In the alternative, a second substrate may be applied or stacked onto the high tack adhesive and the structure is then laminated. In the first alternative, after storing, the release paper is removed, the second substrate is applied and the structure is then laminated. The laminating may be carried out with pressure. A pressure ranging from about 20 to about 50 psi will normally be suitable. A heat lamination step may also be utilized. Both the pressure sensitive adhesives and latent-cure adhesives may be used in the above lamination processes.

The PSAs described above are low T_{g} materials that exhibit good bonding characteristics to plastic panels or substrates such as polyethyleneterephthalate (PET), polyethersulfonic acid (PES), propylene glycol mon-n-butyl ether (PNB), etc. In contrast, the latent-cure adhesives described above are high T_{g} materials. Thus, end users have the freedom to select high or low T_{g} adhesives depending on their requirements. The PSAs and latent-cure adhesives are also applicable to optoelectronic substrates which, in addition to plastics, include glass, metal and ceramic materials.

Numerous modifications or variations in the practice of the invention are expected to occur to those skilled in the art upon consideration of the presently preferred embodiments disclosed herein. Consequently, the only limitations which would be placed upon the scope of the invention are those which appear in the appended claims.

What is claimed:

1. A method of laminating two panels of a flat panel display, the method comprising:
providing a first panel with an inner surface partially coated with a first conductive layer;
providing a second panel with an inner surface partially coated with second conductive layer;
applying adhesive directly to at least one of the first and second conductive layers;
laminating the first panel to the second panel by aligning the first and second conductive layers with the adhesive sandwiched therebetween to adhere the first conductive layer to the second conductive layer with the adhesive.

2. The method of claim 1 wherein the adhesive is a pressure sensitive adhesive.

3. The method of claim 2 wherein the pressure sensitive adhesive is curable with ultra-violet light.

4. The method of claim 2 wherein the pressure sensitive adhesive comprises:
at least one oligomer having a glass transition temperature Tg of less than or about 25° C.; at least one monomer;
at least one resin;
at least one adhesion promoter;
at least one photo initiator.

5. The method of claim 2 wherein the pressure sensitive adhesive comprises:
from about 5 to about 80 wt % of at least one oligomer having a glass transition temperature Tg of less than or about 25° C.;
from about 0 to about 70 wt % of at least one monomer;
from about 5 to about 80 wt % of at least one resin;
from about 0 to about 20 wt % of at least one adhesion promoter;
from about 0 to about 10 wt % of at least one photo initiator.

6. The method of claim 2 wherein the pressure sensitive adhesive comprises:
from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof;
from about 0 to about 70 wt % of at least one monomer selected from the group consisting of isobornyl acrylate, hexanediol diacrylate, phenoxyethyl acrylate and mixtures thereof;
from about 5 to about 80 wt % of at least one resin selected from the group consisting of thermoplastic terpene, thermoplastic polyterpene, styrene butadiene, tall oil resin and mixtures thereof;
from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof;
from about 0 to about 10 wt % of at least one adhesion promoter selected from the group consisting of zirconium salt, titanium salt, and mixtures thereof;
from about 0 to about 10 wt % of at least one photo initiator selected from the group consisting of benzophenone, ethyl-4-(dimethylamino)benzoate, benzil dimethyl ketal and mixtures thereof.

7. The method of claim 1 wherein the adhesive comprises:
from about 40 to about 70 wt % of a urethane diacrylate oligomer;
from about 5 to about 15 wt % of ethoxy ethoxy ethyl acrylate monomer;
from about 15 to about 35 wt % of a terpene resin;
from about 1 to about 5 wt % of gamma-mercaptopropyltrimethoxysilane; and
from about 5 to about 10 wt % benzil dimethyl ketal.

8. The method of claim 1 wherein the adhesive is a latent-cure adhesive.

9. The method of claim 8 wherein the latent-cure adhesive comprises:
an epoxy oligomer;
a reactive diluent;
an adhesion promoter; and
a photo initiator.

10. The method of claim 8 wherein the latent-cure adhesive comprises:
from about 5 to about 95 wt % of at least one epoxy oligomer;
from about 0 to about 70 wt % of at least one reactive diluent;
from about 0.1 to about 10 wt % of at least one photo initiator; and
from about 0 to about 10 wt % of at least one adhesion promoter.

11. The method of claim 8 wherein the latent-cure adhesive comprises:
from about 5 to about 95 wt % of at least one epoxy oligomer selected from the group consisting of bisphenol-A epoxy, bisphenol-F epoxy and mixtures thereof;
from about 0 to about 70 wt % of at least one reactive diluent selected from the group consisting of alcohols, polyols, polyether polyols, vinyl ethers and mixtures thereof;
from about 0.1 to about 10 wt % of a photo initiator selected from the group consisting of triarylsulfonium hexafluoroantimonate salt, triarylsulfonium hexafluorophosphate salt and mixtures thereof; and
from about 0 to about 10 wt % of at least one silane functional epoxy.

12. The method of claim 11 wherein the reactive diluent is selected from the group consisting of glycol, glycol derivatives, n-propyl alcohol and lilmonene dioxide.

13. The method of claim 1 wherein the applying of the adhesive is performed by a process selected from the group consisting of screen printing, offset printing, pattern printing, syringe dispensing and precision dispensing.

14. A method of laminating two panels of a flat panel display, the method comprising:
providing a first panel with an inner surface partially coated with a first conductive layer;
providing a second panel with an inner surface partially coated with second conductive layer;
applying pressure sensitive adhesive directly to at least one of the first and second conductive layers;
laminating the first panel to the second panel by aligning the first and second conductive layers with the pressure sensitive adhesive sandwiched therebetween to adhere the first conductive layer to the second conductive layer with the pressure sensitive adhesive and without the presence of any additional insulating material disposed between the first and second conducting layers other than the pressure sensitive adhesive.

15. The method of claim 14 wherein the pressure sensitive adhesive is curable with ultra-violet light.

16. The method of claim 15 wherein the pressure sensitive adhesive comprises:
at least one oligomer having a glass transition temperature Tg of less than or about 25° C.;
at least one monomer;
at least one resin;
at least one adhesion promoter;
at least one photo initiator.

17. The method of claim 16 wherein the pressure sensitive adhesive comprises:
from about 5 to about 80 wt % of at least one oligomer having a glass transition temperature Tg of less than or about 25° C.;
from about 0 to about 70 wt % of at least one monomer;
from about 5 to about 80 wt % of at least one resin;
from about 0 to about 20 wt % of at least one adhesion promoter;
from about 0 to about 10 wt % of at least one photo initiator.

18. The method of claim 16 wherein the pressure sensitive adhesive comprises:
from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof;
from about 0 to about 70 wt % of at least one monomer selected from the group consisting of isobornyl acrylate, hexanediol diacrylate, phenoxyethyl acrylate and mixtures thereof;
from about 5 to about 80 wt % of at least one resin selected from the group consisting of thermoplastic terpene, thermoplastic polyterpene, styrene butadiene, tall oil resin and mixtures thereof;
from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof;
from about 0 to about 10 wt % of at least one adhesion promoter selected from the group consisting of zirconium salt, titanium salt, and mixtures thereof;
from about 0 to about 10 wt % of at least one photo initiator selected from the group consisting of benzophenone, ethyl-4-(dimethylamino)benzoate, benzil dimethyl ketal and mixtures thereof.

19. The method of claim 16 wherein the pressure sensitive adhesive comprises:
from about 40 to about 70 wt % of a urethane diacrylate oligomer;
from about 5 to about 15 wt % of ethoxy ethoxy ethyl acrylate monomer;
from about 15 to about 35 wt % of a terpene resin;
from about 1 to about 5 wt % of gamma-mercaptopropyltrimethoxysilane; and
from about 5 to about 10 wt % benzil dimethyl ketal.

20. A method of laminating two panels of a flat panel display, the method comprising:
providing a first panel with an inner surface partially coated with a first conductive layer;
providing a second panel with an inner surface partially coated with second conductive layer;
applying a latent-cure sensitive adhesive directly to at least one of the first and second conductive layers;
laminating the first panel to the second panel by aligning the first and second conductive layers with the latent-cure adhesive sandwiched therebetween to adhere the first conductive layer to the second conductive layer with the latent-cure adhesive and without the presence of any additional insulating material disposed between the first and second conducting layers other than the latent-cure adhesive.

21. The method of claim 20 wherein the latent-cure adhesive comprises:
an epoxy oligomer;
a reactive diluent;
an adhesion promoter; and
a photo initiator.

22. The method of claim 20 wherein the latent-cure adhesive comprises:
from about 5 to about 95 wt % of at least one epoxy oligomer;
from about 0 to about 70 wt % of at least one reactive diluent;
from about 0.1 to about 10 wt % of at least one photo initiator; and
from about 0 to about 10 wt % of at least one adhesion promoter.

23. The method of claim 20 wherein the latent-cure adhesive comprises:
from about 5 to about 95 wt % of at least one epoxy oligomer selected from the group consisting of bisphenol-A epoxy, bisphenol-F epoxy and mixtures thereof;
from about 0 to about 70 wt % of at least one reactive diluent selected from the group consisting of alcohols, polyols, polyether polyols, vinyl ethers and mixtures thereof;
from about 0.1 to about 10 wt % of a photo initiator selected from the group consisting of triarylsulfonium hexafluoroantimonate salt, triarylsulfonium hexafluorophosphate salt and mixtures thereof; and
from about 0 to about 10 wt % of at least one silane functional epoxy.

24. The method of claim 20 wherein the reactive diluent is selected from the group consisting of glycol, glycol derivatives, polyalcohols, n-propyl alcohol and limonene dioxide.

25. The method of claim 20 further comprising curing the latent-cure adhesive with ultra-violet light.

26. A flat panel display comprising:
a first panel with an inner surface partially coated with a first conductive layer, a second panel with an inner surface partially coated with second conductive layer,
the first and second conductive layers being connected with an adhesive that is sandwiched therebetween and without the presence of any additional insulating material disposed between the first and second conducting layers other than the adhesive.

27. The flat panel display of claim 26 wherein the adhesive is a pressure sensitive adhesive.

28. The flat panel display of claim 27 wherein the pressure sensitive adhesive is curable with ultra-violet light.

29. The flat panel display of claim 27 wherein the pressure sensitive adhesive comprises:
at least one oligomer having a glass transition temperature Tg of less than or about 25° C.;
at least one monomer;
at least one resin;
at least one adhesion promoter;
at least one photo initiator.

30. The flat panel display of claim 27 wherein the pressure sensitive adhesive comprises:
from about 5 to about 80 wt % of at least one oligomer having a glass transition temperature Tg of less than or about 25° C.;
from about 0 to about 70 wt % of at least one monomer;
from about 5 to about 80 wt % of at least one resin;
from about 0 to about 20 wt % of at least one adhesion promoter;
from about 0 to about 10 wt % of at least one photo initiator.

31. The flat panel display of claim 27 wherein the pressure sensitive adhesive comprises:
from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof;
from about 0 to about 70 wt % of at least one monomer selected from the group consisting of isobornyl acrylate, hexanediol diacrylate, phenoxyethyl acrylate and mixtures thereof;
from about 5 to about 80 wt % of at least one resin selected from the group consisting of thermoplastic terpene, thermoplastic polyterpene, styrene butadiene, tall oil resin and mixtures thereof;
from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof;
from about 0 to about 10 wt % of at least one adhesion promoter selected from the group consisting of zirconium salt, titanium salt, and mixtures thereof;
from about 0 to about 10 wt % of at least one photo initiator selected from the group consisting of benzophenone, ethyl-4-(dimethylamino)benzoate, benzil dimethyl ketal and mixtures thereof.

32. The flat panel display of claim 27 wherein the adhesive comprises:
from about 40 to about 70 wt % of a urethane diacrylate oligomer;
from about 5 to about 15 wt % of ethoxy ethoxy ethyl acrylate monomer;
from about 15 to about 35 wt % of a terpene resin;
from about 1 to about 5 wt % of gamma-mercaptopropyltrimethoxysilane; and
from about 5 to about 10 wt % benzil dimethyl ketal.]

33. The flat panel display of claim 26 wherein the adhesive is a latent-cure adhesive.

34. The flat panel display of claim 33 wherein the latent-cure adhesive comprises:
an epoxy oligomer;
a reactive diluent;
an adhesion promoter; and
a photo initiator.

35. The flat panel display of claim 33 wherein the latent-cure adhesive comprises:
from about 5 to about 95 wt % of at least one epoxy oligomer;
from about 0 to about 70 wt % of at least one reactive diluent;
from about 0.1 to about 10 wt % of at least one photo initiator; and
from about 0 to about 10 wt % of at least one adhesion promoter.

36. The flat panel display of claim 33 wherein the latent-cure adhesive comprises:
from about 5 to about 95 wt % of at least one epoxy oligomer selected from the group consisting of bisphenol-A epoxy, bisphenol-F epoxy and mixtures thereof;
from about 0 to about 70 wt % of at least one reactive diluent selected from the group consisting of alcohols, polyols, polyether polyols, vinyl ethers and mixtures thereof;
from about 0.1 to about 10 wt % of a photo initiator selected from the group consisting of triarylsulfonium hexafluoroantimonate salt, triarylsulfonium hexafluorophosphate salt and mixtures thereof; and
from about 0 to about 10 wt % of at least one silane functional epoxy.

37. The flat panel display of claim 36 wherein the reactive diluent is selected from the group consisting of ethylene glycol, n-propyl alcohol and limonene dioxide.

38. A method of laminating two panels of a flat panel display comprising:
providing a first panel with an inner surface;
coating the inner surface with a pressure sensitive adhesive or a latent-cure adhesive;
applying a second panel to the inner surface of the first panel with the adhesive disposed therebetween; and
curing the adhesive by exposing the first and second panels and adhesive to UV light.

39. The method of claim 38 wherein the adhesive is a pressure sensitive adhesive that comprises:
from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof;
from about 0 to about 70 wt % of at least one monomer selected from the group consisting of isobornyl acrylate, hexanediol diacrylate, phenoxyethyl acrylate and mixtures thereof;
from about 5 to about 80 wt % of at least one resin selected from the group consisting of thermoplastic terpene, thermoplastic polyterpene, styrene butadiene, tall oil resin and mixtures thereof;
from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof;
from about 0 to about 10 wt % of at least one adhesion promoter selected from the group consisting of zirconium salt, titanium salt, and mixtures thereof;
from about 0 to about 10 wt % of at least one photo initiator selected from the group consisting of benzophenone, ethyl-4-(dimethylamino)benzoate, benzil dimethyl ketal and mixtures thereof.

40. The method of claim 39 wherein the adhesive is a latent-cure adhesive that comprises:
from about 5 to about 95 wt % of at least one epoxy oligomer selected from the group consisting of bisphenol-A epoxy, bisphenol-F epoxy and mixtures thereof;
from about 0 to about 70 wt % of at least one reactive diluent selected from the group consisting of alcohols, polyols, polyether polyols, vinyl ethers and mixtures thereof;
from about 0.1 to about 10 wt % of a photo initiator selected from the group consisting of triarylsulfonium hexafluoroantimonate salt, triarylsulfonium hexafluorophosphate salt and mixtures thereof; and
from about 0 to about 10 wt % of at least one silane functional epoxy.

41. A method of laminating two panels of a flat panel display comprising:
providing a first panel with an inner surface;
applying adhesive to the inner surface of the first panel;
curing the adhesive by exposing the adhesive and first panel to UV light to provide a high tack adhesive coating or to initiate the latent-cure adhesive on the inner surface of the first panel;
stacking a second panel on the high tack adhesive coating disposed on the inner surface of the first panel; and
laminating the first and second panels together.

42. The method of claim 41 further comprising the following steps between the curing and the stacking of the second panel on the high tack adhesive:
applying release paper to the high tack adhesive;
storing the first panel, high tack adhesive and release paper;
removing the release paper; and
applying a second panel to the high tack adhesive.

43. The method of claim 41 wherein the adhesive is a pressure sensitive adhesive that comprises:
from about 5 to about 80 wt % of at least one oligomer having a glass transition temperature Tg of less than or about 25° C., the at least one oligomer being selected from the group consisting of aliphatic urethanes, aromatic urethanes, polyester acrylates and mixtures thereof;
from about 0 to about 70 wt % of at least one monomer selected from the group consisting of isobornyl acrylate, hexanediol diacrylate, phenoxyethyl acrylate and mixtures thereof;
from about 5 to about 80 wt % of at least one resin selected from the group consisting of thermoplastic terpene, thermoplastic polyterpene, styrene butadiene, tall oil resin and mixtures thereof;
from about 0 to about 10 wt % of at least one cross-linkable adhesion promoter selected from the group consisting of polyazamide silane, aminoalkyl silane, gamma-mercaptopropyltrimethoxysilane, vinyltrimethoxysilane, methyltriethoxysilane, gamma-methacryloxypropyltrimethoxysilane, bis-(3[triethoxysily]propyl)tetrasulfane and mixtures thereof;
from about 0 to about 10 wt % of at least one adhesion promoter selected from the group consisting of zirconium salt, titanium salt, and mixtures thereof;
from about 0 to about 10 wt % of at least one photo initiator selected from the group consisting of benzophenone, ethyl-4-(dimethylamino)benzoate, benzil dimethyl ketal and mixtures thereof.

44. The method of claim 41 wherein the adhesive is a latent-cure adhesive that comprises:
from about 5 to about 95 wt % of at least one epoxy oligomer selected from the group consisting of bisphenol-A epoxy, bisphenol-F epoxy and mixtures thereof;
from about 0 to about 70 wt % of at least one reactive diluent selected from the group consisting of alcohols, polyols, polyether polyols, vinyl ethers and mixtures thereof;
from about 0.1 to about 10 wt % of a photo initiator selected from the group consisting of triarylsulfonium hexafluoroantimonate salt, triarylsulfonium hexafluorophosphate salt and mixtures thereof; and
from about 0 to about 10 wt % of at least one silane functional epoxy.

45. A method for bonding two substrates or an optoelectronic device together, the method comprising:
applying a pressure sensitive adhesive to at least one of the substrates;
activating the pressure sensitive adhesive with ultraviolet light; and
pressing the two substrates together with the adhesive disposed therebetween.

46. A method for bonding two substrates or an optoelectronic device together, the method comprising:
applying a latent-cure to at least one of the substrates;
activating the latent-cure with ultraviolet light; and
pressing the two substrates together with the adhesive disposed therebetween.
